(19) United States
(12) Patent Application Publication
(10) Pub. No.: US 2025/0294105 A1
(43) Pub. Date: Sep. 18, 2025

(54) IMAGE FORMING APPARATUS

(71) Applicants: Kazumasa KIMURA, Kanagawa (JP); Yuuta SAITOH, Tokyo (JP)

(72) Inventors: Kazumasa KIMURA, Kanagawa (JP); Yuuta SAITOH, Tokyo (JP)

(73) Assignee: Ricoh Company, Ltd., (omitted)

(21) Appl. No.: 19/055,581

(22) Filed: Feb. 18, 2025

(30) Foreign Application Priority Data
Mar. 12, 2024 (JP) 2024-038455

(51) Int. Cl. H04N 1/00

(52) U.S. Cl. CPC H04N 1/00896; H04N 1/00814

(57) ABSTRACT

An image forming apparatus includes a scanner, a plotter, an operation panel, and circuitry. The circuitry controls the scanner and the plotter and relays a request from an external device. The circuitry detects a setting of a document on the scanner, a setting of a sheet in the plotter, and an opening and a closing of each of the scanner cover and the plotter cover. The circuitry determines which of the scanner or the plotter is to be recovered from an energy-saving mode, based on a time that has passed since the setting of the sheet to obtain a first determination result, and based on a use history of an application to obtain a second determination result, and recover the scanner or the plotter from the energy-saving mode based on at least one of triggers and at least one of the first determination result or the second determination result.

### CROSS-REFERENCE TO RELATED APPLICATION

This patent application is based on and claims priority pursuant to 35 U.S.C. § 119 (a) to Japanese Patent Application No. 2024-038455, filed on Mar. 12, 2024, in the Japan Patent Office, the entire disclosure of which is hereby incorporated by reference herein.

### BACKGROUND

### Technical Field

The present disclosure relates to an image forming apparatus.

### Related Art

The image forming apparatus has an energy-saving mode in which a controller cuts off power supply to most of systems in the image forming apparatus. The image forming apparatus includes multiple covers such as a scanner cover and a plotter cover (in other words, a printer cover) and mechanisms to detect setting a document on the scanner and setting sheets in a tray. The controller cancels the energy-saving mode based on an operation such as opening or closing one of the multiple covers, setting the document on the scanner, or setting the sheets in the tray and determines a system to which power is supplied. Performing the energy-saving mode as described above can reduce energy consumption in the image forming apparatus.

### SUMMARY

The present disclosure described herein provides the image forming apparatus including a scanner, a plotter, an operation panel, and circuitry. The scanner includes a scanner cover. The plotter includes a plotter cover. The operation panel receives user input. The circuitry is configured to control the scanner, control the plotter, relay a request from an external device, detect a setting of a document on the scanner and a setting of a sheet in the plotter, and detect an opening and a closing of each of the scanner cover and the plotter cover. The circuitry is configured to determine which of the scanner or the plotter is to be recovered from an energy-saving mode, based on a time that has passed since the setting of the sheet in the plotter to obtain a first determination result. The circuitry is configured to determine which of the scanner or the plotter is to be recovered from the energy-saving mode, based on a use history of an application to obtain a second determination result. The circuitry is configured to recover at least one of the scanner or the plotter from the energy-saving mode based on at least one of triggers and at least one of the first determination result or the second determination result. The triggers include the user input received by the operation panel, the opening and the closing of one of the plotter cover and the scanner cover, and the setting of the document on the scanner and the setting of the sheet in the plotter.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a hardware configuration of an image forming apparatus in an image forming system;

FIG. 2 is a diagram illustrating a system configuration of the image forming apparatus of FIG. 1;

FIG. 3 is a block diagram of a functional configuration of a relay system in the image forming apparatus of FIG. 1;

FIG. 4 is a sequence diagram regarding activation and recovery of control systems that are changed by a detected time that has passed since a sheet was set in the image forming apparatus of FIG. 1;

FIG. 5 is a use case diagram illustrating how a user operation causes activations of a scanner control system, a plotter control system, and a relay system from an energy-saving mode when an image forming apparatus recovers from an energy-saving mode;

FIG. 6 is a flowchart of a recovery operation activated by a time that has passed since a sheet was set in the image forming apparatus of FIG. 1;

FIG. 7 is a flowchart of a recovery operation activated by use history of applications in the image forming apparatus of FIG. 1;

FIG. 8 is a flowchart of a recovery operation activated by a time that has passed since a sheet was set in the image forming apparatus of FIG. 1 and use history of applications in the image forming apparatus of FIG. 1; and

FIG. 9 is a front view of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

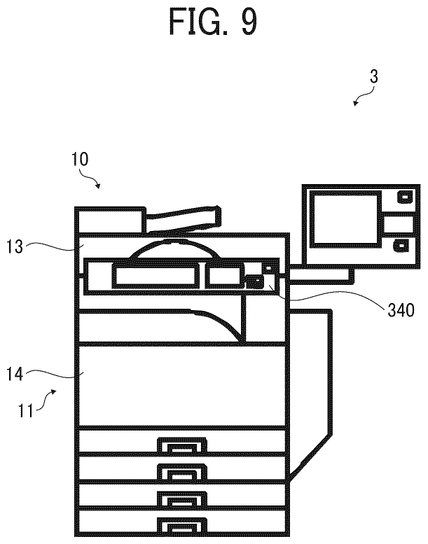

The following describes an embodiment of an image forming apparatus in detail with reference to the accompanying drawings. As illustrated in FIG. 9, an image forming apparatus 3 includes a scanner 10, a plotter 11, and an operation panel 340. The scanner 10 includes a scanner cover 13. Opening the scanner cover 13 enables a document to be placed on the scanner 10. The scanner 10 includes an automatic document feeder (ADF). A document may be placed on the ADF, the ADF automatically conveys the document, and the scanner reads the document. The plotter 11 includes a plotter cover 14. Opening the plotter cover 14 enables toner to be supplied to the plotter 11. The covers 13 and 14 each have an opening and closing detection sensor. Opening or closing each of the covers cause the opening and closing detection sensor to generate an opening signal or a closing signal. These signals are sent to a central processing unit (CPU) 301 in the image forming apparatus 3.

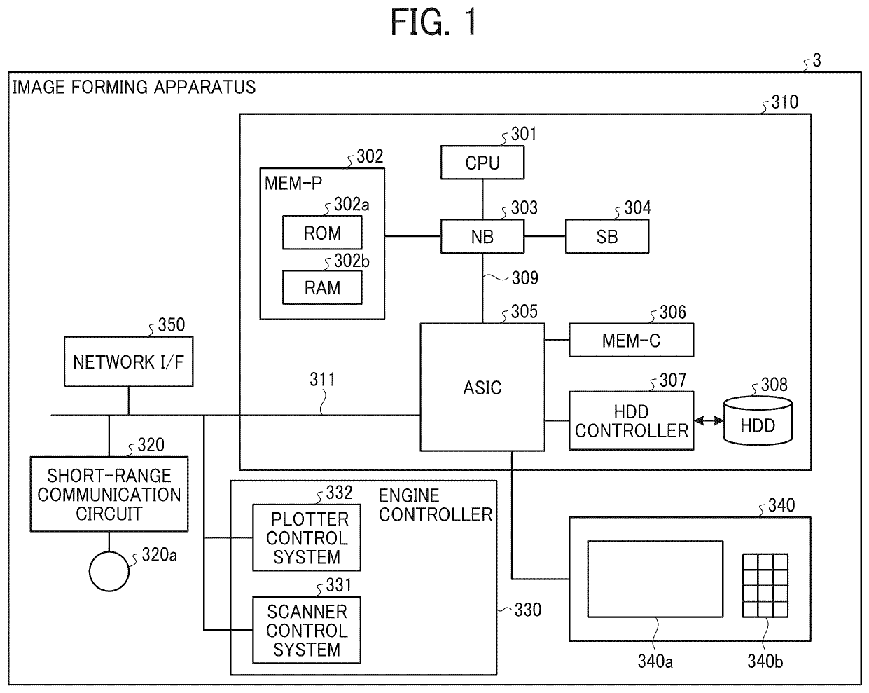

With reference to FIG. 1, a hardware configuration of the image forming apparatus is described. FIG. 1 is a block diagram illustrating the hardware configuration of the image forming apparatus in an image forming system.

An image forming apparatus 3 is configured as a multifunction peripheral (MFP). The image forming apparatus 3 includes a controller 310, a short-range communication circuit 320, an engine controller 330, the operation panel 340, and a network interface (I/F) 350.

The controller 310 controls an entire operation of the image forming apparatus 3 and controls, for example, drawing, communication, and input from the operation panel 340. Specifically, the controller 310 includes the CPU 301 as a main processor, a system memory (MEM-P) 302, a north bridge (NB) 303, a south bridge (SB) 304, an application-specific integrated circuit (ASIC) 305, a local memory (MEM-C) 306 as a storage, a hard disk drive (HDD) controller 307, and a hard disk drive (HDD) 308 as a storage. The NB 303 and the ASIC 305 are connected through an accelerated graphics port (AGP) bus 309.

The CPU 301 is a processor that controls the entire operation of the image forming apparatus 3.

The NB 303 connects the CPU 301 to the MEM-P 302, the SB 304, and the AGP bus 309. The NB 303 includes a memory controller that controls reading or writing of various data from or to the MEM-P 302, a Peripheral Component Interconnect (PCI) master, and an AGP target.

The MEM-P 302 includes a read-only memory (ROM) 302a as a memory that stores programs and data for implementing various functions of the controller 310. The MEM-P 302 further includes a random-access memory (RAM) 302b as a memory that deploys the program and data, or as a drawing memory that stores drawing data for printing.

The program stored in the ROM 302a may be stored in any computer-readable storage (recording) medium, such as a compact disc-read only memory (CD-ROM), compact disc-recordable (CD-R), or digital versatile disc (DVD), in a file format installable or executable by the computer, for distribution.

The SB 304 is a bridge that connects the NB 303 to PCI devices and peripheral devices.

The ASIC 305 is an integrated circuit (IC) dedicated to image processing and includes hardware elements for image processing. The ASIC 305 serves as a bridge to connect the AGP bus 309, a PCI bus 311, the HDD 308, and the MEM-C 306 to each other.

The ASIC 305 includes a PCI target, an AGP master, an arbiter (ARB) as a central processor of the ASIC 305, a memory controller for controlling the MEM-C 306, a plurality of Direct Memory Access Controllers (DMACs) capable of converting coordinates of image data with a hardware logic, and a PCI unit that transfers data between a scanner control system 331 and a plotter control system 332 through the PCI bus 311.

The ASIC 305 may be connected to a universal serial bus (USB) interface, or the Institute of Electrical and Electronics Engineers 1394 (IEEE1394) interface.

The MEM-C 306 is a local memory used as a buffer for an image to be copied or a buffer for coding.

The HDD 308 is a storage (memory) that stores image data, font data used in printing, and form data. The HDD controller 307 controls reading from or writing to the HDD 308 according to the control of the CPU 301.

The AGP bus 309 is a bus interface for a graphics accelerator card, which has been proposed to accelerate graphics processing. Through directly accessing the MEM-P 302 by high throughput, the speed of the graphics accelerator card increases.

The short-range communication circuit 320 includes a short-range communication antenna 320a. The short-range communication circuit 320 is a communication circuit that communicates in compliance with a near field communication (NFC) or the BLUETOOTH (registered trademark), for example.

The engine controller 330 includes the scanner control system 331 and the plotter control system 332. The scanner control system 331 or the plotter control system 332 includes an image processing unit performing image processing such as error diffusion processing and gamma conversion processing.

The operation panel 340 includes a display panel 340a and an operation panel 340b. The display panel 340a is, for example, a touch panel that displays current settings or a selection screen and receives user input. The operation panel 340b includes, for example, a numeric keypad and a start key. The numeric keypad receives assigned values of image forming parameters such as an image density parameter. The start key receives an instruction to start copying, for example.

The image forming apparatus 3 can sequentially switch among a document server function, a copier function, a printer function, and a facsimile function in accordance with input via, for example, an application switch key on the operation panel 340. When the document box function is selected, the image forming apparatus 3 operates in a document box mode. When the copier function is selected, the image forming apparatus 3 operates in a copy mode. When the printer function is selected, the image forming apparatus 3 operates in a printer mode. When the facsimile function is selected, the image forming apparatus 3 operates in a facsimile mode.

The network I/F 350 is an interface for performing data communications using the communication network NT. The short-range communication circuit 320 and the network I/F 350 are electrically connected to the ASIC 305 through the PCI bus 311.

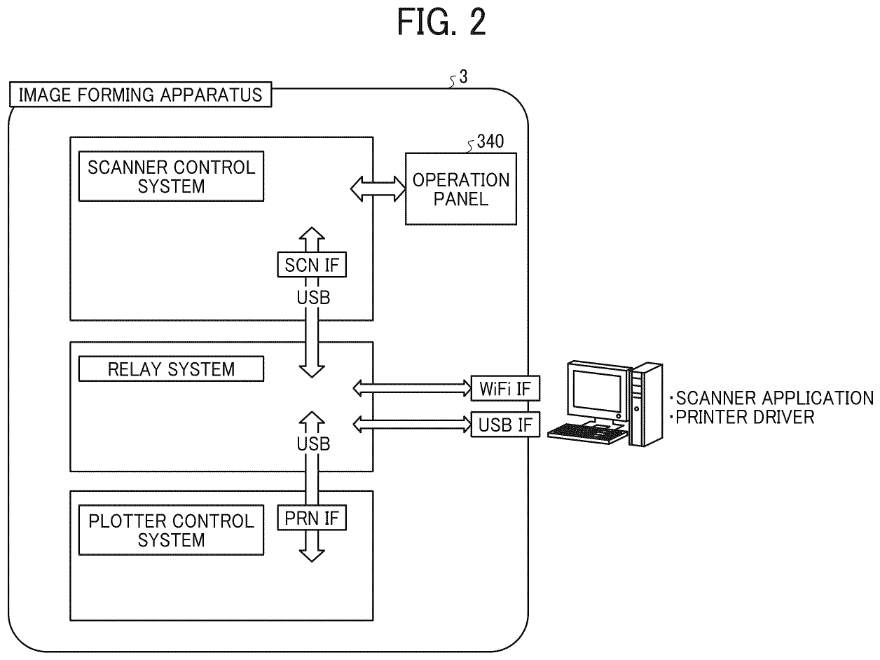

FIG. 2 is a diagram illustrating a system configuration of the image forming apparatus 3. As illustrated in FIG. 2, the image forming apparatus 3 includes three systems that are a scanner control system to control the scanner 10 (that is an example of a scanner), a plotter control system to control the plotter 11 (that is an example of a plotter), and a relay system to control the scanner control system and the plotter control system and relay a request from an external device. The operation panel 340 is coupled to the scanner control system and controlled by the scanner control system. In other words, the image forming apparatus 3 includes circuitry to control the scanner and a printer as the plotter and relay the request from the external device.

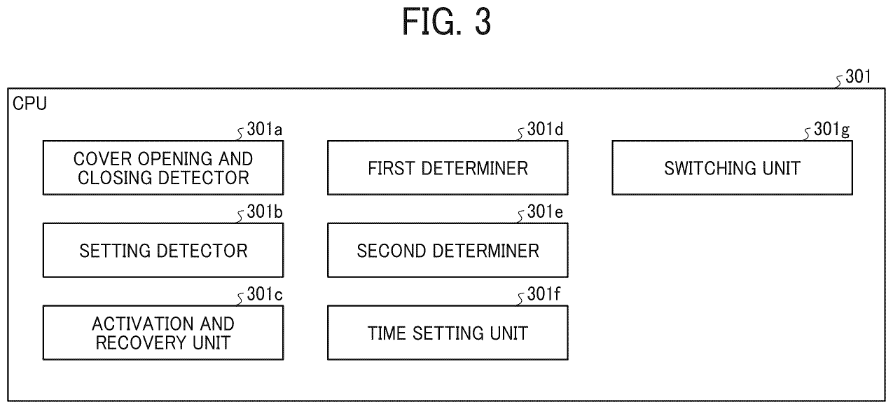

FIG. 3 is a block diagram of a functional configuration of the relay system in the image forming apparatus 3. In the relay system, the CPU 301 executes a program stored in the ROM 302a using the RAM 302b as a work area to implement a cover opening and closing detector 301a, a setting detector 301b, an activation and recovery unit 301c, a first determiner 301d, a second determiner 301e, a time setting unit 301f, and a switching unit 301g. In other words, the circuitry in the image forming apparatus 3 functions as the cover opening and closing detector 301a, the setting detector 301b, the activation and recovery unit 301c, the first determiner 301d, the second determiner 301e, the time setting unit 301f, and the switching unit 301g.

The cover opening and closing detector 301a detects opening and closing any one of multiple covers including the scanner cover 13 of the scanner 10 and the plotter cover 14 of the plotter 11. In the following description, the plotter cover and the scanner cover are referred to simply as covers.

The setting detector 301b detects setting of a document (document set) on the scanner 10 and setting of sheets (print sheet set) in the plotter 11.

The activation and recovery unit 301c recovers the scanner control system or the plotter control system from the energy-saving mode to activate the scanner control system or the plotter control system when any one of an operation on the operation panel 340, opening and closing of one of the covers, setting a document on the scanner, setting a sheet in the plotter is detected. The activation and recovery unit 301c recovers the scanner control system or the plotter control system from the energy-saving mode to activate the scanner control system or the plotter control system based on a first determination result of the first determiner 301d and a second determination result of the second determiner 301e, which are described below.

In recovery from the energy-saving mode based on a trigger that is any one of opening and closing one of covers, setting the document on the scanner, and setting the sheet in the plotter, the above-described configuration enables referring to a time that has passed since the sheet was set in the plotter or the latest use history of an application, which can provide a recovery function from the energy-saving mode corresponding to user needs. Since a user can quickly use a function that is actually frequently used, the above-described configuration enhances the work efficiency. In addition, the above-described configuration can achieve an optimum recovery from the energy-saving mode based on a user's use history of applications, reducing power consumption.

The first determiner 301d determines which of the scanner control system and the plotter control system is to be activated and recovered from the energy-saving mode, based on the time that has passed since the sheet was set in the plotter to obtain the first determination result. For example, when a predetermined number of days or more have not passed since the sheet was set in the plotter 11, the first determiner 301d determines to recover the plotter control system in addition to the scanner control system from the energy-saving mode even if the power is turned on due to a scanner factor related to the scanner 10. The predetermined number of days as a predetermined time is a preset number of days, and may be 60 days, for example.

As a result, detecting the period after the user lastly sets the sheet in the plotter enables recovering the image forming apparatus 3 from the energy-saving mode considering that the user may use the plotter 11, which reduces the user's standby time until the user uses the plotter 11 and enhances the user's convenience.

The second determiner 301e determines which of the scanner control system and the plotter control system is to be activated and recovered from the energy-saving mode, based on the use history of the applications to obtain the second determination result. For example, when the second determiner 301e refers to the use history of the applications and determines that only the scanner 10 is used, the second determiner 301e determines activating and recovering the scanner control system from the energy-saving mode even when any recovery trigger is detected.

In contrast, when the second determiner 301e refers to the use history of the applications and determines that only the printer function is used, the second determiner 301e determines activating and recovering the plotter control system from the energy-saving mode even when any recovery trigger is detected. Referring to the use history of the applications enables preferentially activating the control system that executes the application having a high probability of being used by the user and thus can save power.

The time setting unit 301f sets the predetermined time, for example, the predetermined number of days. The switching unit 301g is configured to switch between enabling and disabling the determination function of the second determiner 301e. The time setting unit 301f enables adjusting the detected period after the user lastly sets the sheet in the plotter to a number of days desired by the user. In other words, when the user wants to disable the determination function of the second determiner 301e, the user operates the operation panel to perform key input for disabling the determination function of the second determiner 301e, and the circuitry as the switching unit 301g in the image forming apparatus 3 stops obtaining the second determination result obtained by the second determiner 301e based on the user input. When the user wants to adjust the predetermined number of days, the user inputs the predetermined number of days desired by the user to the operation panel, and the circuitry as the time setting unit 301f in the image forming apparatus 3 changes the predetermined number of days as the predetermined time based on the user input. The switching unit 301g enables switching between the recovery from the energy-saving mode based on the use history of the applications and the recovery from the energy-saving mode based on the detected period after the user lastly sets the sheet in the plotter. As a result, the time setting unit 301f and the switching unit 301g enable adjustment according to the way of working for each user.

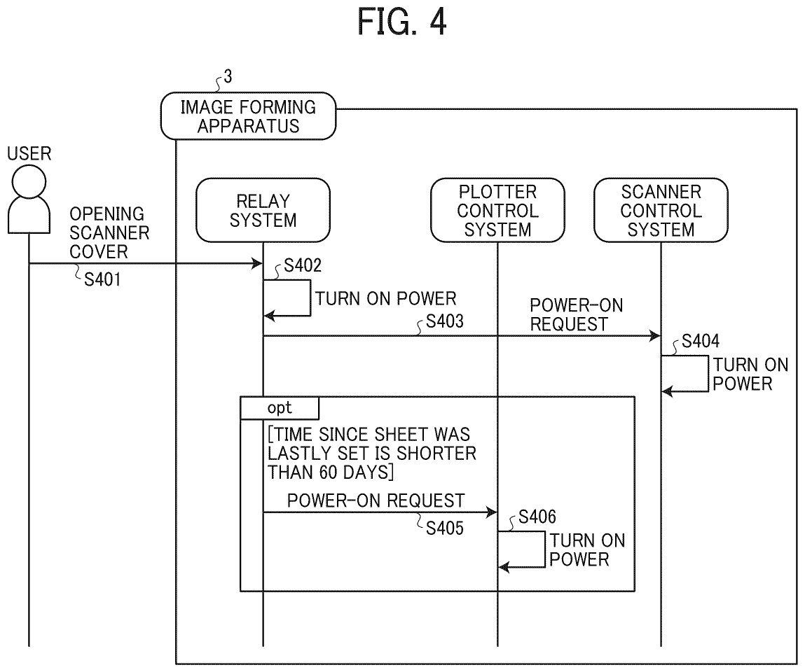

FIG. 4 is a sequence diagram regarding activation and recovery of control systems that are changed by a detected time that has passed since the sheet was set in the image forming apparatus. This sequence illustrates how the three systems recover from the energy-saving mode when the user opens the scanner cover 13 of the scanner 10. Opening the scanner cover 13 of the scanner 10 is one of the triggers to start an energy-saving recovery operation (that is an operation to recover the system from the energy saving mode).

The flow of the recovery processes from the energy-saving mode is as follows. After the user opens the scanner cover (step S401), the relay system is activated (step S402). Opening the scanner cover is the recovery trigger regarding the scanner (the scanner factor). Therefore, the relay system executes a power-on request to the scanner control system to turn on the scanner control system (steps S403 and S404). Subsequently, the relay system determines whether to recover the plotter control system from the energy-saving mode based on the time that has passed since the sheet was set in the plotter. Specifically, the setting detector 301b included in the CPU 301 detects an operation to set the sheet in the image forming apparatus, and a timer in the image forming apparatus measures the time that has passed since the sheet was set. The relay system refers to the measured time and determines whether to recover the plotter control system from the energy-saving mode.

In FIG. 4, the relay system determines that the user recently used the plotter performing the printer function and the copy function based on information that the time that has passed since the sheet was lastly set is less than the predetermined time (for example, 60 days) and activates the plotter control system in addition to the scanner control system (step S405 and step S406). The above-described control enables immediately performing operations regarding the plotter even in the case of the recovery due to the scanner factor. As a result, the above-described control reduces the waiting time for a user and enhances the user's convenience. FIG. 4 illustrates a specific time that is 60 days as an example of the predetermined time. However, the user can operate the time setting unit 301f to set the predetermined time. The user can operate the time setting unit 301f to turn on or off recovery from the energy-saving mode due to the predetermined time. The user can freely change the predetermined time. Thus, the user can adjust the image forming apparatus 3 to reflect the user's usage tendency, which enhances the user's convenience.

Table 1 below illustrates the factors of triggers related to the recovery from the energy-saving mode and the systems recovered from the energy-saving mode by the triggers without referring the use history of the applications. Table 2 below illustrates the factors of triggers related to the recovery from the energy-saving mode and the systems recovered from the energy-saving mode that are determined by referring the use history of the applications in addition to the triggers. For the sake of simplicity, the contents of Table 2 represent a case where the scanner application is set as an application to be preferentially used.

TABLE 1

| | Scanner control | | Relay | Plotter control |
|---|---|---|---|---|
| | system | | system | system |
| Trigger | System | Panel | System | System |
| Opening the scanner cover | ON | ON | ON | OFF |
| Opening the plotter cover | OFF | OFF | ON | ON |
| Setting the document | ON | ON | ON | OFF |
| on the scanner | | | | |
| Setting the sheet | OFF | OFF | ON | ON |
| in the plotter | | | | |
| Operation on the | ON | ON | ON | OFF |
| operation panel | | | | |

TABLE 2

| | Scanner control | | Relay | Plotter control |
|---|---|---|---|---|
| | system | | system | system |
| Trigger | System | Panel | System | System |
| Opening the scanner cover | ON | ON | ON | OFF |
| Opening the plotter cover | ON | ON | ON | OFF |
| Setting the document | ON | ON | ON | OFF |
| on the scanner | | | | |
| Setting the sheet | ON | ON | ON | ON |
| in the plotter | | | | |
| Operation on the | ON | ON | ON | OFF |
| operation panel | | | | |

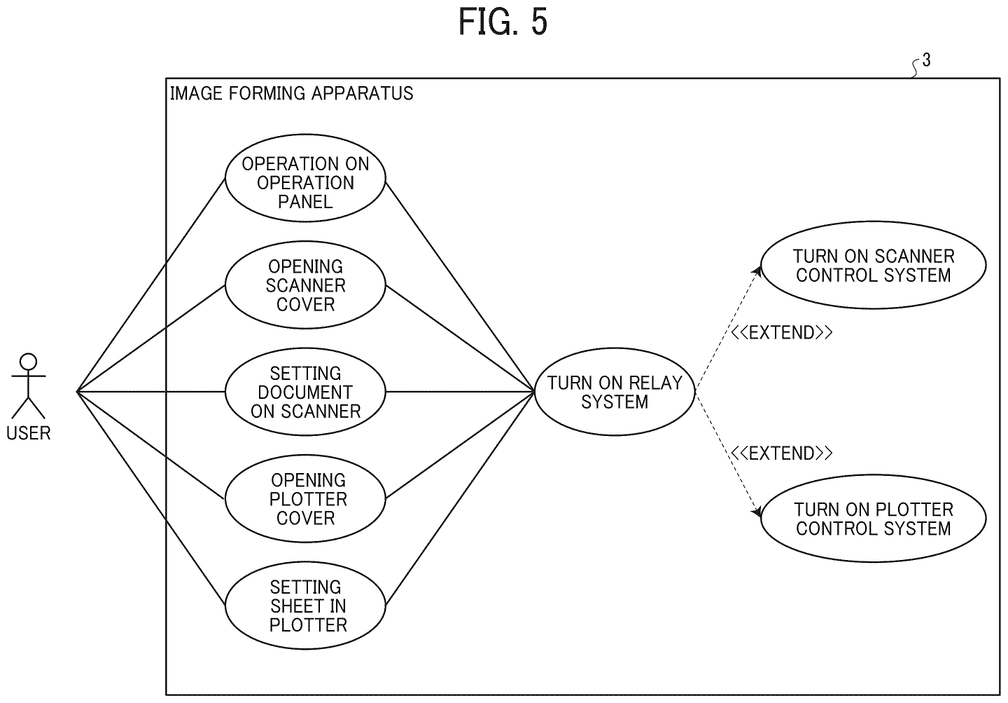

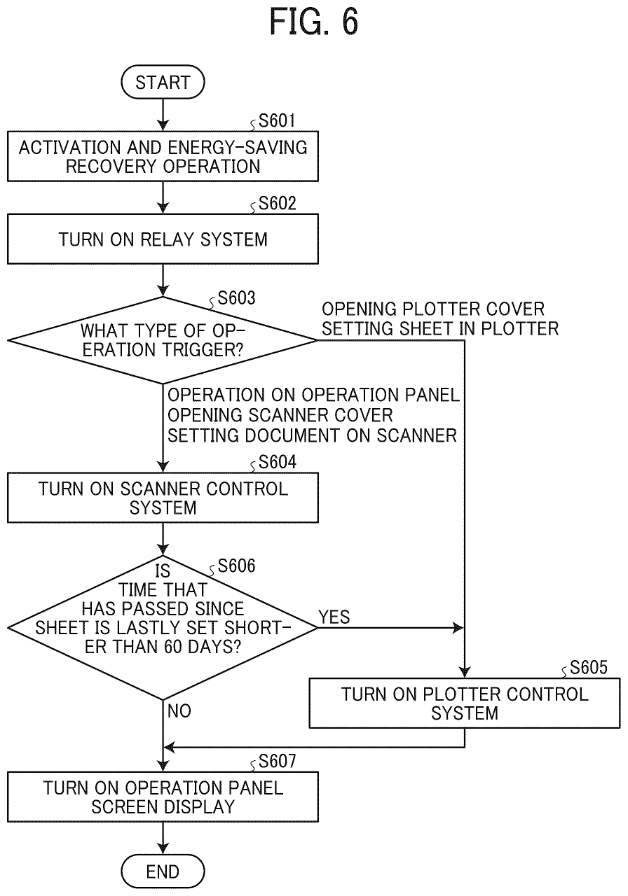

FIG. 5 is a use case diagram illustrating how a user operation causes activations of the scanner control system, the plotter control system, and the relay system from the energy-saving mode when the image forming apparatus recovers from the energy-saving mode. When the user performs any one of five activation and energy-saving recovery operations (for example, the operation on the operation panel 340, opening the scanner cover of the scanner 10, setting a document on the scanner 10, opening the plotter cover 14 of the plotter 11, and setting the sheet in the plotter 11) on the image forming apparatus 3 during the energy-saving mode to use the image forming apparatus 3, the power of the relay system in the image forming apparatus 3 is firstly turned on to activate other systems. Subsequently, the first determiner 301d detects the time that has passed since the sheet was set, the second determiner 301e refers to the use history of the applications, and the activation and recovery unit 301c suitably activates the system desired by the user. The flow of processes and the detailed conditional branching of which system is to be activated is described below with reference to the flowcharts in FIGS. 6 to 8.

FIG. 6 is a flowchart of a recovery operation activated by the time that has passed since the sheet was set in the image forming apparatus. To simplify the flow of processing, FIG. 6 illustrates processing when the first determiner functions based on the detected time that has passed since the sheet was set.

In step S601, one of the activation and energy-saving recovery operations is performed to recover the image forming apparatus 3 from the energy-saving mode. In step S602, the power of the relay system is turned on. After the relay system is activated, the system to be powered on next changes depending on the type of the activation energy-saving recovery operation (an operation trigger).

If the operation trigger of the activation energy-saving recovery operation is the operation on the operation panel 340 or the scanner factor (for example, opening the scanner cover 13 of the scanner 10 or setting the document on the scanner 10) (step S603: the operation on the operation panel or the scanner factor), the activation and recovery unit 301c turns on the power of the scanner control system (step S604). In contrast, if the operation trigger is a printer factor (for example, opening the plotter cover 14 of the plotter 11 and setting the sheet) (step S603: the printer factor), the activation and recovery unit 301c turns on the power of the plotter control system (step S605).

After the scanner control system is activated due to the scanner factor (step S604), the first determiner 301d determines whether the time that has passed since the sheet was lastly set is longer than the predetermined time set by the user (for example, 60 days) (step S606). If the time that has passed since the sheet was lastly set is equal to or longer than the predetermined time (No in step S606), the activation and recovery unit 301c proceeds step S607 to turn on the operation panel screen display. If the time that has passed since the sheet was lastly set is shorter than the predetermined time (Yes in step S606), the activation and recovery unit 301c predicts that the user is likely to use the plotter because the user recently used the plotter before the predetermined time has passed and additionally turns on the power of the plotter control system (step S605).

The first determiner 301d determines whether the time that has passed since the setting detector 301b lastly detected the setting of the sheet is shorter than the predetermined time. Based on the determination of the first determiner 301d, the activation and recovery unit 301c activates the plotter control system even when the power of the relay system is turned on due to the scanner factor. This control reduces the standby time to use the plotter 11 and enhances the user's convenience.

When the plotter prints all sheets set in the plotter and includes no sheet, the first determiner 301d resets the time that has passed since the setting detector 301b lastly detected the setting of the sheet to be zero. When the size of the sheet is changed while the user uses the copy function, the first determiner 301d determines that the sheet is set again and resets the time that has passed since the setting detector 301b lastly detected the setting of the sheet, to be zero. There is an exceptional case. For example, the user removes the sheets from the plotter to eliminate the deflection of the sheets and sets the sheets in the plotter again. In such a case, the sheets are set again for a short time (for example, within 5 minutes) after the sheets are removed. Accordingly, the first determiner 301d does not reset the time that has passed since the setting detector 301b lastly detected the setting of the sheet when the sheets are set again for the short time after the sheets are removed.

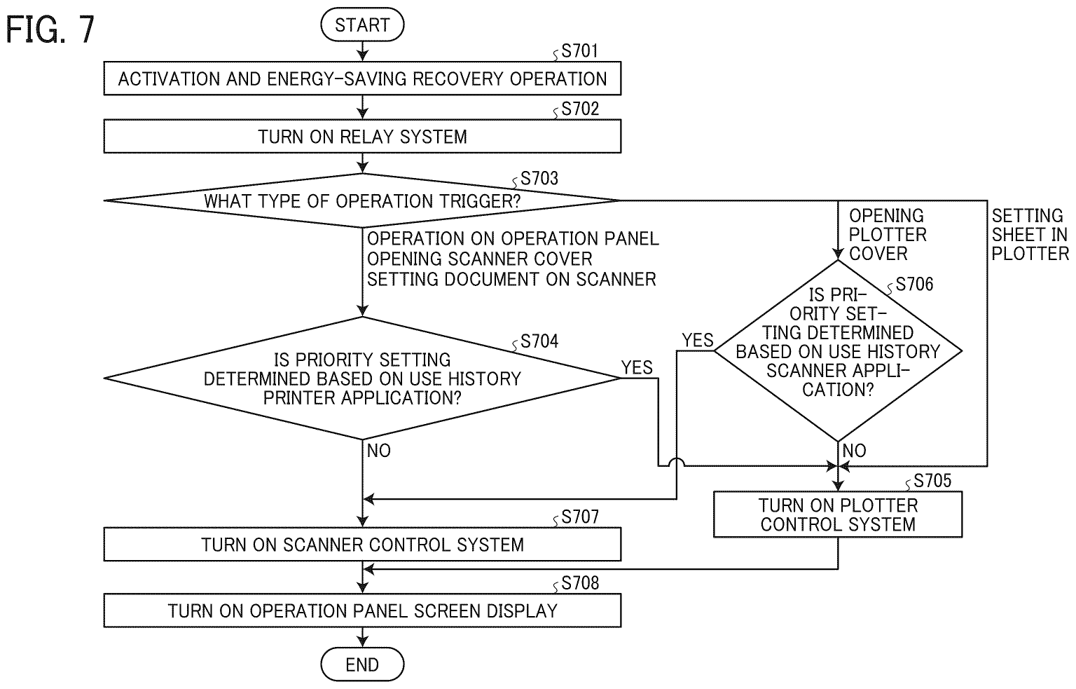

FIG. 7 is a flowchart of a recovery operation activated by the use history of applications in the image forming apparatus. To simplify the flow of processing, FIG. 7 illustrates processing when the second determiner preferentially functions and determines based on the use history of the applications.

In step S701, one of the activation and energy-saving recovery operations is performed to recover the image forming apparatus 3 from the energy-saving mode. In step S702, the power of the relay system is turned on. After the relay system is activated, the system to be powered on next changes depending on the type of the activation energy-saving recovery operation (the operation trigger). When the priority setting of the use history of the applications is ON, the system to be powered on next changes.

If the activation energy-saving recovery operation is the operation on the operation panel 340 or the scanner factor (step S703: the operation on the operation panel or the scanner factor), the second determiner 301e refers to the latest use history of the applications and determines a priority setting of the application based on the latest use history. When the second determiner determines the priority setting of the printer application (Yes in step S704), the activation and recovery unit 301c turns on the power of the plotter control system (step S705) and does not turn on the scanner control system. In contrast, if the activation energy-saving recovery operation is opening the plotter cover of the plotter (step S703: the printer factor), the second determiner 301e refers to the latest use history of the applications and determines a priority setting of the application based on the latest use history. When the second determiner determines the priority setting of the scanner application (Yes in step S706), the activation and recovery unit 301c turns on the power of the scanner control system (step S707) and does not turn on the plotter control system.

If the activation energy-saving recovery operation is setting the sheet in the plotter that is the printer factor (step S703: the printer factor), the user is most likely to use the printer application. Accordingly, the second determiner 301e referring to the use history of the applications does not function, and the activation and recovery unit 301c turns on the power of the plotter control system (step S705). As described above, the control referring to the use history of the applications does not depend on the printer factor and the scanner factor that are referred to as recovery factors. Even if the activation energy-saving recovery operation is the scanner factor, the activation and recovery unit 301c turns on the power of the plotter control system and does not turn on the scanner control system based on the determination that the priority setting is the printer application. Even if the activation energy-saving recovery operation is the printer factor, the activation and recovery unit 301c turns on the power of the scanner control system and does not turn on the plotter control system based on the determination that the priority setting is the scanner application. The above-described control can reflect the use needs of the user and save power. After the power of the scanner control system is turned on (step S707) or after the power of the plotter control system is turned on (step S705), the activation and recovery unit 301c proceeds to step S708 to turn on the operation panel screen display.

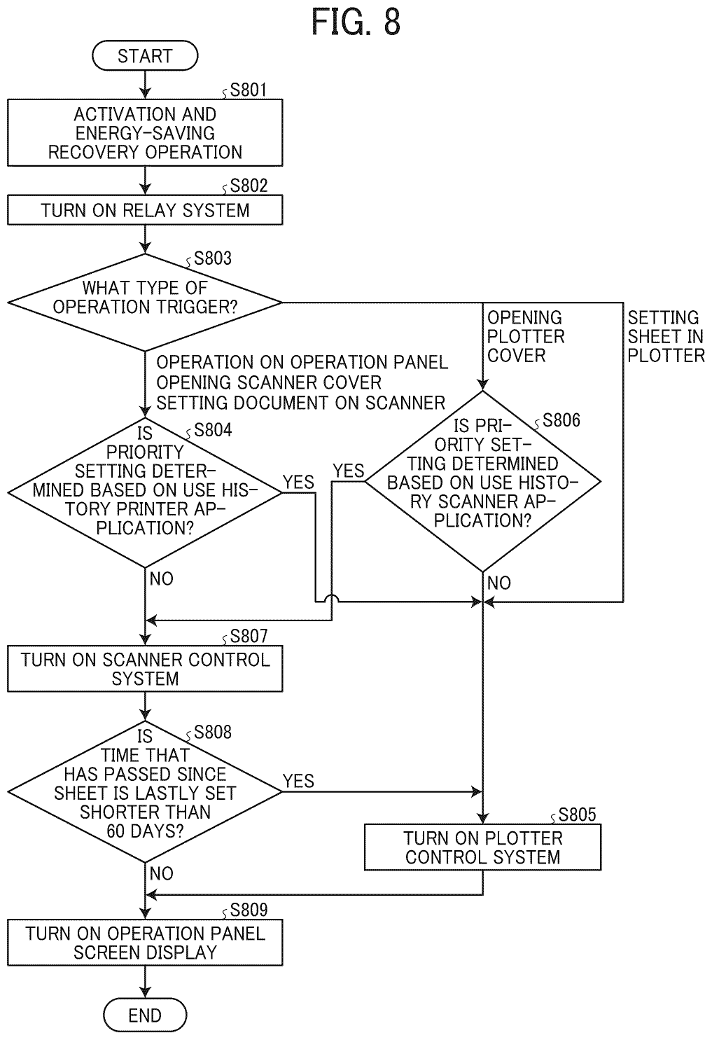

FIG. 8 is a flowchart of a recovery operation activated by the time that has passed since the sheet was set in the image forming apparatus and the use history of applications in the image forming apparatus.

In step S801, one of the activation and energy-saving recovery operations is performed to recover the image forming apparatus 3 from the energy-saving mode. In step S802, the power of the relay system is turned on. After the relay system is activated, the system to be powered on next changes depending on the type of the activation energy-saving recovery operation (operation trigger). When the priority setting of the use history of the applications is ON, the system to be powered on next changes.

If the activation energy-saving recovery operation is the scanner factor (step S803: the operation on the operation panel or the scanner factor), the second determiner 301e refers to the latest use history of the applications and determines a priority setting of the application. When the second determiner determines the priority setting of the printer application (Yes in step S804), the activation and recovery unit 301c turns on the power of the plotter control system (step S805) and does not turn on the scanner control system.

In contrast, if the activation energy-saving recovery operation is opening the plotter cover of the plotter (step S803: opening the plotter cover), the second determiner 301e refers to the latest use history of the applications and determines a priority setting of the application. When the second determiner determines the priority setting of the scanner application (Yes in step S806), the activation and recovery unit 301c turns on the power of the scanner control system (step S807) and does not turn on the plotter control system.

If the activation energy-saving recovery operation is setting the sheet in the plotter that is the printer factor (step S803: setting the sheet in the plotter), the user is most likely to use the printer application. Accordingly, the second determiner 301e referring to the use history of the applications does not function, and the activation and recovery unit 301c turns on the power of the plotter control system (step S805).

When the scanner control system is activated (step S807), the first determiner 301d determines whether the time that has passed since the sheet was lastly set is longer than the predetermined time set by the user (step S808). If the time that has passed since the sheet was lastly set is equal to or longer than the predetermined time (No in step S808), the activation and recovery unit 301c proceeds step S809 to turn on the operation panel screen display. If the time that has passed since the sheet was lastly set is shorter than the predetermined time (Yes in step S808), the activation and recovery unit 301c predicts that the user is likely to use the plotter because the user recently used the plotter before the predetermined time has passed and additionally turns on the power of the plotter control system (step S805).

In the recovery from the energy-saving mode based on a trigger that is any one of opening and closing the one of covers, setting the document on the scanner, and setting the sheet in the plotter, the image forming apparatus 3 described above enables referring to the time that has passed since the sheet was set in the plotter or the latest use history of the application, which can provide a recovery function from the energy-saving mode corresponding to user needs.

The program executed by the image forming apparatus 3 is preinstalled and provided in, for example, the ROM 302a. Alternatively or additionally, the program executed by the image forming apparatus 3 is stored in a computer-readable storage medium, such as a compact disc read-only memory (CD-ROM), a flexible disk (FD), a compact disc-recordable (CD-R), and a digital versatile disc (DVD), in an installable or executable file format, to be provided.

Alternatively or additionally, the program executed by the image forming apparatus 3 is stored in a computer connected to a network such as the Internet and downloaded through the network, thus being providable. Alternatively or additionally, the program executed by the image forming apparatus 3 is provided or distributed via a network such as the Internet.

The program executed by the image forming apparatus 3 has a module configuration including the above-described units (the cover opening and closing detector 301a, the setting detector 301b, the activation and recovery unit 301c as the activation and recovery circuitry, the first determiner 301d, the second determiner 301e, the time setting unit 301f as the data setting circuitry, and the switching unit 301g as the switching circuitry). In terms of actual hardware, the processor such as the CPU 301 reads the program from the ROM 302a and executes the program, and thus the units are loaded onto a main memory, and the cover opening and closing detector 301a, the setting detector 301b, the activation and recovery unit 301c as the activation and recovery circuitry, the first determiner 301d, the second determiner 301e, the time setting unit 301f as the data setting circuitry, and the switching unit 301g as the switching circuitry is generated on the main memory.

Although, in the above embodiments, the description is provided is of a case in which the image forming apparatus according to the embodiments is a multifunction peripheral having at least two of the copier function, the printer function, the scanner function, and the facsimile function, this is merely one example. In another example, aspects of this disclosure are applicable to any image forming apparatus such as a copier, a printer, a scanner, or a facsimile machine.

Aspects of the present disclosure are, for example, as follows.

### <First Aspect>

In a first aspect, an image forming apparatus includes a scanner control system, a plotter control system, a relay system, an operation panel, multiple covers, a cover opening and closing detector, a setting detector, an activation and recovery unit, a first determiner, and a second determiner. The scanner control system controls a scanner. The plotter control system controls a plotter. The relay system controls the scanner control system and the plotter control system and relays a request from an external device. The multiple covers include a cover of the scanner and a cover of the plotter. The cover opening and closing detector detects opening and closing the covers. The setting detector 301b detects setting a document on the scanner and setting a sheet in the plotter. The activation and recovery unit recovers the scanner control system or the plotter control system from the energy-saving mode to activate the scanner control system or the plotter control system when any one of an operation on the operation panel, opening and closing of one of the covers, setting a document on the scanner, and setting a sheet in the plotter is detected. The first determiner determines which of the scanner control system and the plotter control system is to be activated and recovered from the energy-saving mode, based on the time at which the sheet was set in the plotter. The second determiner determines which of the scanner control system and the plotter control system is to be activated and recovered from the energy-saving mode, based on the use history of the applications. The activation and recovery unit recovers the scanner control system or the plotter control system from the energy-saving mode to activate the scanner control system or the plotter control system based on determination results of the first determiner and the second determiner.

### <Second Aspect>

In a second aspect, the first determiner in the image forming apparatus according to the first aspect determines to recover the plotter control system from the energy-saving mode based on a time shorter than a predetermined time that has passed from the time at which the sheet was set in the plotter even if the power is turned on due to a scanner factor related to the scanner.

### <Third Aspect>

In a third aspect, the second determiner in the image forming apparatus according to the first aspect or the second aspect refers to a use history of applications and, when only the scanner is used, determines activating and recovering the scanner control system from the energy-saving mode and, when only the copy is used, determines activating and recovering the plotter control system from the energy-saving mode.

### <Fourth Aspect>

In a fourth aspect, the image forming apparatus according to the second aspect further includes a time setting unit to set the predetermined time and a switching unit to switch between enabling and disabling a determination function of the second determiner.

Note that the present disclosure is not limited to the above-described embodiments. Within the scope of the present disclosure, those skilled in the art may change, add, or convert each element of the above-described embodiments. In addition, one or more embodiments can be appropriately combined with another one or more embodiments within a scope of the disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a scanner including a scanner cover;
a plotter including a plotter cover;
an operation panel to receive user input; and
circuitry configured to:
control the scanner;
control the plotter;
relay a request from an external device;
detect:
a setting of a document on the scanner; and
a setting of a sheet in the plotter;
detect an opening and a closing of each of the scanner cover and the plotter cover;
determine which of the scanner or the plotter is to be recovered from an energy-saving mode, based on a time that has passed since the setting of the sheet in the plotter to obtain a first determination result;
determine which of the scanner or the plotter is to be recovered from the energy-saving mode, based on a use history of an application to obtain a second determination result;
recover at least one of the scanner or the plotter from the energy-saving mode based on at least one of triggers including:
the user input received by the operation panel;
the opening and the closing of one of the plotter cover and the scanner cover; and
the setting of the document on the scanner and the setting of the sheet in the plotter, and
at least one of the first determination result or the second determination result.

2. The image forming apparatus according to claim 1,
wherein the circuitry is further configured to:
determine whether the time is shorter than a predetermined time as the first determination result; and
recover the plotter from the energy-saving mode in response to the time shorter than the predetermined time as the first determination result.

3. The image forming apparatus according to claim 1,
wherein the circuitry is further configured to:
refer to the use history of the application;
determine to recover the scanner from the energy-saving mode based on the use history of the application in which only the scanner is used; and
determine to recover the plotter from the energy-saving mode based on the use history of the application in which only the plotter is used.

4. The image forming apparatus according to claim 1,
wherein the circuitry is further configured to switch between obtaining and not obtaining the second determination result based on the user input.

5. The image forming apparatus according to claim 2,
wherein the circuitry is further configured to change the predetermined time based on the user input.
